(19) United States
(12) Patent Application Publication
(10) Pub. No.: US 2024/0185134 A1
(43) Pub. Date: Jun. 6, 2024

(54) MULTI-TASK OFFLINE REINFORCEMENT LEARNING MODEL BASED ON SKILL REGULARIZED TASK DECOMPOSITION AND MULTI-TASK OFFLINE REINFORCEMENT LEARNING METHOD USING THE SAME

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Min Jong YOO, Suwon-si (KR); Sang Woo CHO, Suwon-si (KR)

(73) Assignee: RESEARCH & BUSINESS FOUNDATION SUNGKYUNKWAN UNIVERSITY, Suwon-si (KR)

(21) Appl. No.: 18/488,246

(22) Filed: Oct. 17, 2023

(30) Foreign Application Priority Data
Nov. 24, 2022 (KR) 10-2022-0159388

(51) Int. Cl. G06N 20/00

(52) U.S. Cl. CPC G06N 20/00

(57) ABSTRACT

A reinforcement learning model is provided. The reinforcement learning model may include a skill regularized task decomposition model configured to perform a skill regularized task decomposition based on a determined data quality and a data augmentation model configured to perform data augmentation by generating an imaginary demo. The skill regularized task decomposition model may perform a skill embedding operation by implementing 2n-step state-action pairs, perform a skill regularization operation by implementing n-step transitions including states, actions, rewards, and next states, and perform an operation of decomposing a task in units of episodes into subtasks in units of n-steps.

### CROSS-REFERENCE TO RELATED APPLICATIONS

This application claims the benefit under 35 USC §119(a) of Korean Patent Application No. 10-2022-0159388 filed on Nov. 24, 2022, in the Korean Intellectual Property Office the entire disclosure of which is incorporated herein by reference for all purposes.

### BACKGROUND

### 1. Field

The following description relates to a reinforcement learning model and a reinforcement learning method, and more specifically, to a multi-task offline reinforcement learning model based on skill regularized task decomposition and a multi-task offline reinforcement learning method using the same.

### 2. Description of Related Art

Reinforcement learning-based control technologies may efficiently solve complex real-world problems using a variety of offline data. However, data given in data-based learning methods that cannot interact with the real environment may be of poor quality in the collected policies or the amount of data may be insufficient. The above problems may greatly reduce offline reinforcement learning performance.

There are two methods of training multi-task learning that learns multiple tasks, including firstly a soft-modularization technique that utilizes a module-based network structure and attention to utilize the knowledge of various tasks, and secondly a gradient surgery method of regulating a gradient generated during update to train to adjust a conflict of knowledge between tasks generated during learning.

However, both the soft-modularization technique and the gradient surgery method have problems with inconsistent data quality and poor learning performance in offline situations where data is insufficient.

Furthermore, a task inference method of learning through inferring a task to be currently performed may have a problem in that it cannot decompose the task into small units of subtasks, making it difficult to share data between other tasks. Therefore, the task inference method causes a problem in that learning performance is reduced in situations where there is insufficient data.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reinforce learning model includes a skill regularized task decomposition model configured to perform a skill regularized task decomposition based on a determined data quality; and a data augmentation model configured to perform data augmentation by generating an imaginary demo, wherein the skill regularized task decomposition model is configured to: perform a skill embedding operation by implementing 2n-step state-action pairs; perform a skill regularization operation by implementing n-step transitions including states, actions, rewards, and next states; and perform an operation of decomposing a task in units of episodes into subtasks in units of n-steps.

The skill regularized task decomposition model may be configured to decompose the task into the subtasks by matching the subtasks to a plurality of skills in units of action sequences, and wherein the data augmentation model may be configured to perform reinforcement learning by sharing a skill of the plurality of skills corresponding to a subtask among the plurality of subtasks.

When performing the skill embedding operation, the skill regularized task decomposition model may be configured to map the 2n-step state-action pairs of offline data to a skill candidate space, and infer the 2n-step state-action pairs by implementing a mapped candidate vector.

The skill embedding operation is performed through training by implementing a skill embedding loss of Equation 1 below:

$${L}_{SE} ( ϕ ) = \frac{1}{m} {\sum }_{i = 1}^{m} {\sum }_{j = - n}^{n - 1} {‖ \text{?} - \text{?} ( \text{?} ( \text{?} ) ) ‖}_{2} + λ {L}_{PR} ( \{ \text{?} ( \{ \text{?} \} \text{?} ) ) ,$$

$$\text{?} \text{indicates text missing or illegible when filed}$$

where

$${L}_{PR} ( \{ b \} , \{ \text{?} \} ) = \frac{1}{m ( m - 1 )} \text{?} k ( \text{?} ) + \frac{1}{m ( m - 1 )} \text{?} k ( \text{?} ) - \frac{1}{{m}^{2}} \text{?} k ( \text{?} ) \text{?}$$

$$\text{?} \text{indicates text missing or illegible when filed}$$

is a skill encoder, p₀ is a skill decoder, aₜ an action at time t, θₜ is a state at time t, \tilde{b} is skill embedding, and dₜ is state-action pairs from t−n to t+n−1).

When performing the skill regularization operation, the skill regularized task decomposition model may be configured to map the n-step transitions to a task candidate space, infer with a same task when the data is above a reference quality, solved by a same skill, and infer with another task when the data is below the reference quality.

The skill regularization operation is performed through training by implementing a skill regularized loss of Equation 2 below:

L_{SRTD}(θ)=L_{TE}(θ)+L_{SR}(θ)+λL_{PR}({\tilde{z}ᵢ}ᵢ₌₁^{m}˜P_{z}, q_{θ}({τₜ_{ᵢ}}ᵢ₌ₐ^{m})), where

$${L}_{TE} ( θ ) = \frac{1}{m} {\sum }_{i = 1}^{m} \text{?} {‖ ( \text{?} , \text{?} ) - {p}_{θ} ( \text{?} , \text{?} , {q}_{θ} ( \text{?} ) ) ‖}_{2} ,$$

$$\text{?} \text{indicates text missing or illegible when filed}$$

$${L}_{SR} = \frac{1}{m} {\sum }_{i = 1}^{m} \text{?} ( \text{?} , \text{?} ) \text{?} {‖ {q}_{θ} ( \text{?} ) - \text{?} ( \text{?} ) ‖}_{2} \text{?}$$

$$\text{?} \text{indicates text missing or illegible when filed}$$

is a task encoder, v₀ is a task decoder, rᵢ is a reward at time t, τ is a transition, θ is a subtask embedding vector, and \tilde{R} is a reward sum of episodes including state-action pairs).

When performing the operation of decomposing the task in units of episodes into the subtasks in units of n-steps, the skill regularized task decomposition model may be configured to infer a subtask by implementing the task encoder trained in the skill regularized process.

The data augmentation model may be configured to generate the imaginary demo by inferring data generated when performing a skill that is appropriate for a given task by implementing the skill regularized task decomposition model, and augment learning data by training by adding subtask information to an input value.

The imaginary demo is generated by Equation 3 below:

[symbol]

, ( [symbol] , [symbol] )=p_{θ}(sₜ, zₜ), p_{θ}(sₜ, [symbol] , zₜ), where zₜ=q_{θ}(τₜ), sₜ is a state at time t, tₜ is a reward at time t, z is a subtask embedding vector, q_{θ} is a task encoder, and vₚ is a task decoder).

A processor-implemented reinforce learning method includes performing a skill regularized task decomposition based on a determined data quality; and performing data augmentation by generating an imaginary demo, wherein the performing of the skill regularized task decomposition comprises: performing a skill embedding operation by implementing 2n-step state-action pairs; performing a skill regularization operation by implementing n-step transitions including states, actions, rewards, and next states; and performing an operation of decomposing a task in units of episodes into subtasks in units of n-steps.

Other features and examples will be apparent from the following detailed description, the drawings, and the claims.

### BRIEF DESCRIPTION OF DRAWINGS

FIG. 1 illustrates a configuration of an example reinforcement learning model according to embodiments of the present disclosure, in accordance with one or more embodiments.

FIG. 2 illustrates a flowchart showing an operation of the example reinforcement learning model of FIG. 1.

FIG. 3 illustrates a flowchart showing operations of a skill regularized task decomposition phase, in accordance with one or more embodiments.

FIG. 4 illustrates a view of a structure of an example skill regularized task decomposition model in consideration of quality, in accordance with one or more embodiments.

FIG. 5 illustrates an algorithm of a learning process of the skill regularized task decomposition model in consideration of quality.

FIG. 6 illustrates a view of a structure of an example data augmentation model through generating an imaginary demo, in accordance with one or more embodiments.

FIG. 7 illustrates a diagram of a robot arm control learning performance to which a reinforcement learning model, in accordance with one or more embodiments, is applied.

FIG. 8 illustrates a diagram showing a drone driving learning performance to which an example reinforcement learning model, in accordance with one or more embodiments, is applied.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

One or more example may provide a reinforcement learning model that enables efficient and stable learning of a control model through skill regularized task decomposition in consideration of data quality in a multi-task offline reinforcement learning environment in which the quality of data is inconsistent and data is insufficient.

One or more examples may provide a reinforcement learning model and a reinforcement learning method that enables efficient and stable learning of a control model through skill regularized task decomposition in consideration of data quality in a multi-task offline reinforcement learning environment in which the quality of data is inconsistent and data is insufficient.

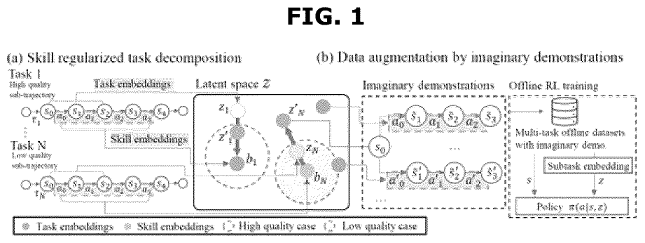

FIG. 1 illustrates a conceptual view of a configuration of a reinforcement learning

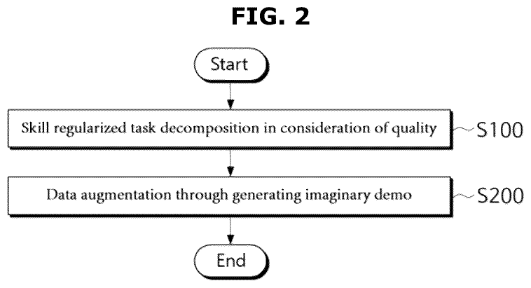

model, in accordance with one or more embodiments, and FIG. 2 is a flowchart showing an operation of the example reinforcement learning model of FIG. 1.

Referring to FIG. 1, the example reinforcement learning model may include a skill regularized task decomposition model that is generated based on a consideration of data quality, and a data augmentation model that is generated by generating an imaginary demo.

For example, the reinforcement learning model of the one or more examples may include a skill regularized task decomposition inference model that includes a skill embedding model and a task embedding model in order to perform stable reinforcement learning despite unobservable environmental changes.

Referring to FIG. 2, the operations in FIG. 2 may be performed in the sequence and manner as shown. However, the order of some operations may be changed, or some of the operations may be omitted, without departing from the spirit and scope of the shown example.

Additionally, operations illustrated in FIG. 2 may be performed in parallel or simultaneously. One or more blocks of FIG. 2, and combinations of the blocks, can be implemented by special purpose hardware-based computer that perform the specified functions, or combinations of special purpose hardware and instructions, e.g., computer or processor instructions. In addition to the description of FIG. 2 below, the descriptions of FIG. 1 are also applicable to FIG. 2 and are incorporated herein by reference. Thus, the above description may not be repeated here for brevity purposes. The operations of FIG. 2 may be performed by a processor, or by one or more processors.

As illustrated in FIG. 2, the reinforcement learning model may perform skill regularized task decomposition in consideration of data quality (operation S100), and may perform data augmentation through generating an imaginary demo (operation S200).

In an example, the skill regularized task decomposition model may decompose a task into subtasks by matching the subtasks to a plurality of skills in units of action sequences.

The task may refer to a Markov decision process that models an environment of reinforcement learning. In an example, the Markov decision process is expressed as a 4-tuple of (S, A, P, R). Each character of (S, A, P, R) may indicate the following:

S: State space, A: Action space, P: Transition probability, R: Reward function .

A multi-task environment refers to an environment that includes multiple tasks, and may generally be expressed as a set of multiple tasks with different transition probabilities and reward functions {(S, A, Pᵢ, Rᵢ)}ᵢ.

A subtask may refer to a target that must be performed over a short period of time in order to perform an entire task. By utilizing subtask embedding (z), a multi-task environment may be expressed as a single Markov decision process (S×Z, A, P, R).

Skill may refer to an action sequence (e.g., a₀, a₁, a₂, . . . , a_{N}) generated by an agent.

In an example, the data augmentation model may perform reinforcement learning by sharing the skill corresponding to the subtask among the plurality of tasks.

Accordingly, the reinforcement learning model of the one or more examples may perform efficient and stable learning of a control model through skill regularized task decomposition in consideration of data quality in a multi-task offline reinforcement learning environment in which the quality of data is inconsistent and data is insufficient.

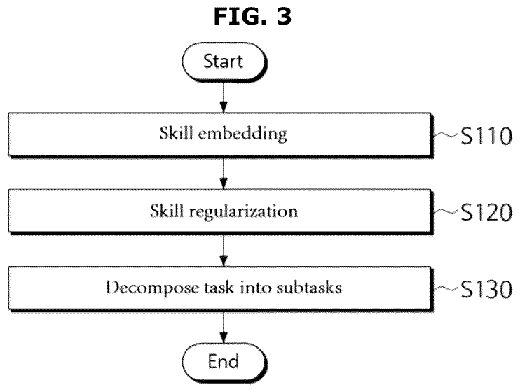

Hereinafter, a more detailed configuration and operation of the reinforcement learning model of the one or more examples will be described through FIGS. 3 to 6.

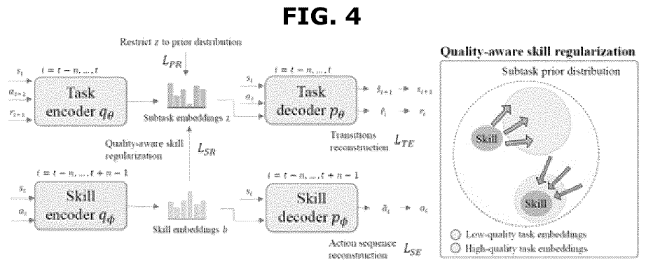

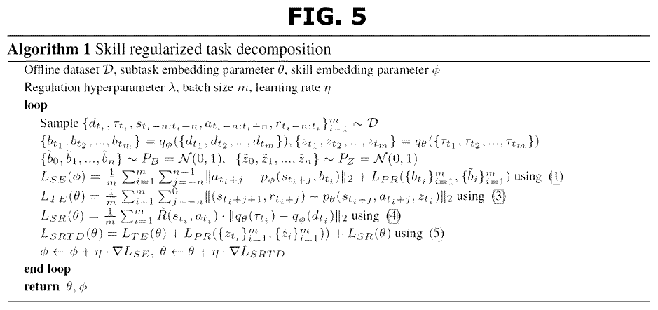

FIG. 3 is a flowchart showing detailed operations of a skill regularized task decomposition phase, FIG. 4 is a view showing a structure of a skill regularized task decomposition model in consideration of quality, and FIG. 5 is an algorithm showing a learning process of the skill regularized task decomposition model in consideration of quality.

The operations in FIG. 3 may be performed in the sequence and manner as shown. However, the order of some operations may be changed, or some of the operations may be omitted, without departing from the spirit and scope of the shown example. Additionally, operations illustrated in FIG. 3 may be performed in parallel or simultaneously. One or more blocks of FIG. 3, and combinations of the blocks, can be implemented by special purpose hardware-based computer that perform the specified functions, or combinations of special purpose hardware and instructions, e.g., computer or processor instructions. In addition to the description of FIG. 3 below, the descriptions of FIGS. 1 and 2 are also applicable to FIG. 3 and are incorporated herein by reference. Thus, the above description may not be repeated here for brevity purposes. The operations of FIG. 3 may be performed by a processor, or by one or more processors.

Referring to FIGS. 3 to 5, the skill regularized task decomposition model may decompose a task into subtasks by matching the subtasks to a plurality of skills in units of action sequences.

In an example, as illustrated in FIG. 3, the skill regularized task decomposition model may perform skill embedding (operation S110), may perform skill regularization (operation S120), and may decompose a task into subtasks (operation S130).

Specifically, the skill regularized task decomposition model may perform an operation of performing skill embedding using 2n-step state-action pairs, an operation of performing skill regularization using n-step transitions including states, actions, rewards, and next states, and an operation of decomposing a task in units of episodes into subtasks in units of n-steps.

In an example, skill embedding may aim to embed an action of a policy function over a short period of time into a specific vector using 2n-step state-action pairs.

When performing the operation of performing skill embedding, the skill regularized task decomposition model may map the 2n-step state-action pairs of offline data to a skill candidate space, and infer the 2n-step state-action pairs using the mapped candidate vector.

Specifically, the skill regularized task decomposition model may map 2n-step state-action pairs of given offline data to a specific skill latent space, infer 2n-step actions that are given during the mapping process using the mapped latent vector and state, and train a skill encoder and a skill decoder using a skill embedding loss.

In an example, the skill embedding may be performed through training using a skill embedding loss of Equation 1 below.

$${L}_{SE} ( ϕ ) = \frac{1}{m} {\sum }_{i = 1}^{m} {\sum }_{j = - n}^{n - 1} {‖ \text{?} - \text{?} ( \text{?} , \text{?} ( \text{?} ) ) ‖}_{2} + λ {L}_{PR} ( \{ \tilde{b} \text{?} ( \{ \text{?} ) ) \qquad Equation 1$$

$$\text{?} \text{indicates text missing or illegible when filed}$$

In an example,

$${L}_{PR} ( \{ b \} , \{ \tilde{b} \} ) = \frac{1}{m ( m - 1 )} \text{?} k ( \text{?} ) + \frac{1}{m ( m - 1 )} \text{?} k ( \text{?} ) - \frac{1}{{m}^{2}} \text{?} k ( \text{?} ) \text{?}$$

$$\text{?} \text{indicates text missing or illegible when filed}$$

is a skill encoder, pₒ is a skill decoder, 0ₜ is an action at time t, dₜ is a state at time t, \tilde{b} is skill embedding, and dₜ is state-action pairs from t−n to tn+n−1.

In an example, skill regularization may aim to decompose a dataset of each task into sharable subtasks.

When performing the operation of performing skill regularization, the task regularized task decomposition model may map n-step transitions to a task candidate space in the example of data above a reference quality, solved by the same skill, infer with the same task in the example of data above the reference quality, and infer with another task in the example of data below the reference quality.

In an example, the skill regularized task decomposition model may map given n-step transitions (states, actions, rewards, next states) to a subtask latent space to be allowed to have the same value as skill embedding when the skill currently performed in this data has received a high reward during the mapping process, and to be allowed to have another value when it has received a low reward.

The skill regularized task decomposition model may match a given task to a skill capable of solving the given task. The skill regularized task decomposition model may train a task encoder and a task decoder using a skill regularized loss.

In an example, the skill regularization may be performed through training using a skill regularized loss of Equation 2 below.

$${L}_{SRTD} ( θ ) = {L}_{TE} ( θ ) + {L}_{SR} ( θ ) + λ {L}_{PR} ( {\{ {\tilde{z}}_{i} \}}_{i = 1}^{m} ∼ {P}_{Z} , {q}_{θ} ( \{ \text{?} ) ) \qquad Equation 2$$

$$\text{?} \text{indicates text missing or illegible when filed}$$

Here,

$${L}_{TE} ( θ ) = \frac{1}{m} {\sum }_{i = 1}^{m} \text{?} {‖ ( \text{?} , \text{?} ) - {p}_{θ} ( \text{?} , \text{?} , {q}_{θ} ( \text{?} ) ) ‖}_{2} ,$$

$$\text{?} \text{indicates text missing or illegible when filed}$$

is a task encoder, p_{θ} is a task decoder, rₜ is a reward at time t, τ is a transition, z is a subtask embedding vector, and \tilde{R} is a reward sum of episodes including state-action pairs.

When performing the operation of decomposing the task in the units of episodes into the subtasks in units of n-steps, the skill regularized task decomposition model may infer a subtask using the task encoder trained in the skill regularized process.

In other words, the skill regularized task decomposition model may decompose a task in units of episodes into subtasks in units of n-steps through matching the task to a skill.

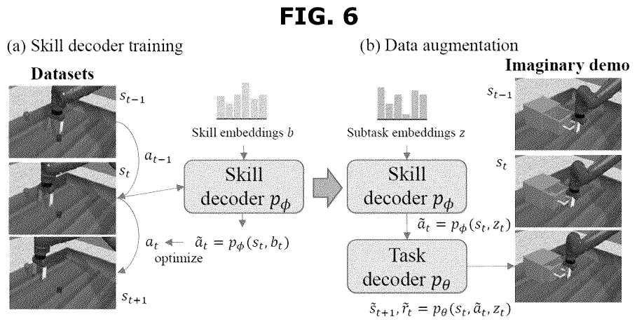

FIG. 6 is a view illustrating a structure of a data augmentation model by generating an imaginary demo.

Referring to FIG. 6, the data augmentation model may perform reinforcement learning by sharing the skill corresponding to the subtask among the plurality of tasks.

The data augmentation model may generate the imaginary demo by inferring data generated when performing a skill that is appropriate for a given task using the skill regularized task decomposition model.

The data augmentation model may augment learning data by training through adding subtask information to an input value.

For example, the imaginary demo may be generated through Equation 3 below.

Equation 3:

[symbol]

, ( [symbol] , [symbol] )=p_{θ}(sₜ, zₜ), p_{θ}(sₜ, [symbol] , zₜ),

Here, z=q_{θ}(τₜ), aₜ is an action at time t, sₜ is a state at time t, rₜ is a reward at time t, z is a subtask embedding vector, q_{θ} is a task encoder, and p_{θ} is a task decoder.

That is, the reinforcement learning model of the one or more examples may train a skill regularized task decomposition model using given data, generate high-quality imaginary data by utilizing a skill decoder and a task decoder trained through skill regularized task decomposition, and train subtask information through adding to a reinforcement learning agent input value using a task encoder trained through skill regularized task decomposition.

As such, according to the reinforcement learning model of the one or more examples, it may be possible to enable efficient and stable learning of a control model through skill regularized task decomposition in consideration of data quality in a multi-task offline reinforcement learning environment in which the quality of data is inconsistent and data is insufficient.

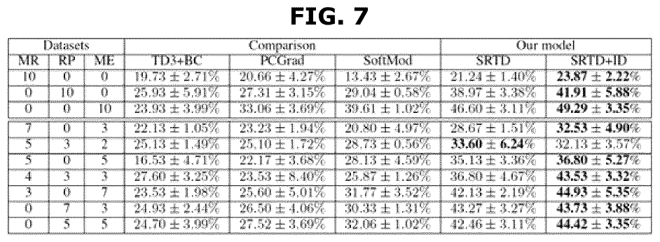

FIG. 7 illustrates a robot arm control learning performance to which a reinforcement learning model, in accordance with one or more embodiments, is applied.

Referring to FIG. 7, it can be confirmed that when robot arm control learning is performed using the reinforcement learning model of the one or more examples (SRTD+ID), learning performance is improved compared to other comparison groups.

Specifically, as shown in FIG. 7, it can be seen that when learning is performed over the same period of time through experiments, the reinforcement learning model of the one or more examples shows an average performance increase of 8.67 to 17.67% compared to a soft modularization method.

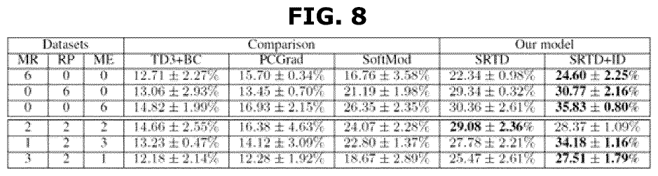

FIG. 8 is a diagram showing a drone driving learning performance to which a reinforcement learning model, in accordance with one or more embodiments, is applied.

Referring to FIG. 8, it can be confirmed that when drone autonomous driving learning is performed using the reinforcement learning model of the one or more examples (SRTD+ID), learning performance is improved compared to other comparison groups.

Specifically, as shown in FIG. 8, it can be seen that when learning is performed over the same period of time through experiments, the reinforcement learning model of the present disclosure has an average performance increase of 5.01 to 11.37% compared to the soft modularization method.

Therefore, in an example where the reinforcement learning model of the one or more examples is applied to the 4th industry such as robots, self-driving drones, and smart factories, it can solve the problems of inconsistent quality of data and lack of data when reinforcement learning is performed without interaction with the real environment, as well as solve the problem that arises when training reinforcement learning to be used in the real world, which has various non-interactable characteristics.

However, the details thereof have been described above, and thus a redundant description thereof will be omitted.

The devices, apparatuses, units, modules, and components described herein with respect to FIGS. 1-8 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application, and illustrated in FIGS. 1-8, are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that be performed by the hardware components and the methods as described above. In one example, the instructions or software include machine code that is directly executed by the one or more processors or computers, such as machine code produced by a compiler. In another example, the instructions or software include higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), EEPROM, RAM, DRAM, SRAM, flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors and computers so that the one or more processors and computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A reinforce learning model, comprising:
a skill regularized task decomposition model configured to perform a skill regularized task decomposition based on a determined data quality; and
a data augmentation model configured to perform data augmentation by generating an imaginary demo, wherein the skill regularized task decomposition model is configured to:
perform a skill embedding operation by implementing 2n-step state-action pairs;
perform a skill regularization operation by implementing n-step transitions including states, actions, rewards, and next states; and
perform an operation of decomposing a task in units of episodes into subtasks in units of n-steps.

2. The reinforce learning model of claim 1, wherein the skill regularized task decomposition model is configured to decompose the task into the subtasks by matching the subtasks to a plurality of skills in units of action sequences, and
wherein the data augmentation model is configured to perform reinforcement learning by sharing a skill of the plurality of skills corresponding to a subtask among the plurality of subtasks.

3. The reinforce learning model of claim 1, wherein when performing the skill embedding operation, the skill regularized task decomposition model is configured to map the 2n-step state-action pairs of offline data to a skill candidate space, and infer the 2n-step state-action pairs by implementing a mapped candidate vector.

4. The reinforce learning model of claim 3, wherein the skill embedding operation is performed through training by implementing a skill embedding loss of Equation 1 below:
Equation 1:
$${L}_{SR} = \frac{1}{m} {\sum }_{i = 1}^{m} \tilde{R} ( \text{?} , \text{?} ) \cdot {‖ {q}_{θ} ( \text{?} ) - \text{?} ( \text{?} ) ‖}_{2} \text{?}$$
$$\text{?} \text{indicates text missing or illegible when filed}$$
is a skill encoder, pₒ is a skill decoder, aₜ is an action at time t, sₜ is a state at time t, \tilde{b} is skill embedding, and dₜ is state-action pairs from t−n to t+n−1).

5. The reinforce learning model of claim 1, wherein when performing the skill regularization operation, the skill regularized task decomposition model is configured to map the n-step transitions to a task candidate space, infer with a same task when the data is above a reference quality, solved by a same skill, and infer with another task when the data is below the reference quality.

6. The reinforce learning model of claim 5, wherein the skill regularization operation is performed through training by implementing a skill regularized loss of Equation 2 below:
$${L}_{SRTD} ( θ ) = {L}_{TE} ( θ ) + {L}_{SR} ( θ ) + λ {L}_{PR} ( {\{ {\tilde{z}}_{i} \}}_{i = 1}^{m} ∼ {P}_{Z} , {q}_{θ} ( \{ \text{?} ) ) ,$$
$$( where , {L}_{TE} ( θ ) = \frac{1}{m} {\sum }_{i = 1}^{m} \text{?} {‖ ( \text{?} , \text{?} ) - {p}_{θ} ( \text{?} , \text{?} , {q}_{θ} ( \text{?} ) ) ‖}_{2} ,$$
$${L}_{SR} = \frac{1}{m} {\sum }_{i = 1}^{m} \tilde{R} ( \text{?} , \text{?} ) \cdot {‖ {q}_{θ} ( \text{?} ) - \text{?} ( \text{?} ) ‖}_{2} \text{?}$$
$$\text{?} \text{indicates text missing or illegible when filed}$$
is a task encoder, p_{θ} is a task decoder, rₜ is a reward at time t, τ is a transition, z is a subtask embedding vector, and \tilde{R} is a reward sum of episodes including state-action pairs).

7. The reinforce learning model of claim 6, wherein when performing the operation of decomposing the task in units of episodes into the subtasks in units of n-steps, the skill regularized task decomposition model is configured to infer a subtask by implementing the task encoder trained in the skill regularized process.

8. The reinforce learning model of claim 1, wherein the data augmentation model is configured to generate the imaginary demo by inferring data generated when performing a skill that is appropriate for a given task by implementing the skill regularized task decomposition model, and augment learning data by training by adding subtask information to an input value.

9. The reinforce learning model of claim 8, wherein the imaginary demo is generated by Equation 3 below:
Equation 3: [symbol]
, ( [symbol] , [symbol] )=p_{θ}(sₜ, zₜ), p_{θ}(sₜ, [symbol] , zₜ),
(where, zₜ=q_{θ}(τₜ), aₜ is an action at time t, sₜ is a state at time t, rₜ is a reward at time t, z is a subtask embedding vector, q_{θ} is a task encoder, and p_{θ} is a task decoder).

10. A processor-implemented reinforce learning method, the method comprising:
performing a skill regularized task decomposition based on a determined data quality; and
performing data augmentation by generating an imaginary demo, wherein the performing of the skill regularized task decomposition comprises:
performing a skill embedding operation by implementing 2n-step state-action pairs;
performing a skill regularization operation by implementing n-step transitions including states, actions, rewards, and next states; and
performing an operation of decomposing a task in units of episodes into subtasks in units of n-steps.
